(19) United States
(12) Patent Application Publication
(10) Pub. No.: US 2026/0340273 A1
(43) Pub. Date: Oct. 29, 2026

(54) UNSUPERVISED MULTI-MODEL OPTIMIZATION FOR RESOURCE-CONSTRAINED DOCUMENT PARSING AT THE EDGE

(71) Applicant: Dell Products L.P., Round Rock, TX (US)

(72) Inventors: Paulo Abelha Ferreira, Rio de Janeiro (BR); Pablo Nascimento da Silva, Niterói (BR); Sarah Hannah Lucius Lacerda de Góes Telles Carvalho Alves, Rio de Janeiro (BR); Vinicius Michel Gottin, Rio de Janeiro (BR); Iam Palatnik de Sousa, Rio de Janeiro (BR)

(21) Appl. No.: 19/188,924

(22) Filed: Apr. 24, 2025

(51) Int. Cl. G06F 40/186; G06F 40/205; G06F 40/40

(52) U.S. Cl. CPC G06F 40/186; G06F 40/205; G06F 40/40

(57) ABSTRACT

One example method for extracting content from a document includes receiving a new document that conforms to a template that is common to one or more documents in a set of documents, applying a splitting strategy to the new document that splits the new document into regions, defining a set of sub-documents, each of the sub-documents corresponding to one of the regions, using respective instances of an LLM (large language model), extracting respective content from each of the sub-documents, and aggregating the content of the sub-documents to define structured.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to the extraction of information from documents. More particularly, at least some embodiments relate to systems, hardware, software, computer-readable media, and methods for unsupervised multi-model optimization for resource-constrained document parsing at the edge.

### BACKGROUND

The data management problem of extracting information from documents, such as scanned documents, and text-based PDFs, for example, is well known. There are numerous instances, across all industries, where solutions to these problems are required. These problems present challenges with regard to document content extraction, and governance, regarding the correct classification, labeling and protection of data, documents, and emails. Furthermore, content extraction is a requirement for RAG-based (Resource-Augmented Generation) tools, which are the state-of-the-art for chatbots and ‘copilot’ support systems. Some approaches employ multimodal LLM (large language models). However, while having more regions in a document from which content is to be extracted, and thus more models, improves results, such an approach is also more compute intensive. A significant problem is that having many models for many smaller regions does not necessarily mean that the models can be smaller.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings. Color versions of the figures are set forth in the attached Appendix A which is incorporated herein its entirety by this reference.

FIG. 1 discloses aspects of a set of documents conforming to a template.

FIG. 2 discloses aspects of a baseline approach for multimodal information extraction, according to one embodiment.

FIG. 3 an example of a separation of the template into regions (represented by colors) and the parallel information extraction, according to one embodiment.

FIG. 4 discloses a masking procedure to generate a ‘sub-document’ for a region (the sub-document is of same size as the original document but has all content outside the region obscured/erased), according to one embodiment.

FIG. 5 discloses aspects of a method according to one embodiment.

FIG. 6 discloses aspects of a multi-objective genetic algorithm approach to determine a substantially optimal document splitting strategy Rh, according to one embodiment.

FIG. 7 discloses a representation of two document splitting strategies—one R₀ assigning all elements to the same region; one R₁ assigning elements to three distinct regions, according to one embodiment.

FIG. 8 discloses an example algorithm for an initial candidate generation procedure, according to one embodiment.

FIG. 9 discloses an approach for assessing strategy R for document d, according to one embodiment.

FIG. 10 discloses self-similarity scores for documents D as obtained by the regions splitting strategy candidate R (the aggregate-by-region scores s₀, s₁, . . . , sₖ are the output for the strategy candidate R).

FIG. 11 discloses re-indexing of regions, according to one embodiment.

FIG. 12 discloses creation (by crossover of two candidates) of new candidate Rn, according to one embodiment.

FIG. 13 discloses an example of a single-element mutation changing the region of element with index 3 from region 0 to (pre-existing) region 1, according to one embodiment.

FIG. 14 discloses an alternative multi-element mutation in a same scenario as in FIG. 13, according to one embodiment.

FIG. 15 discloses an example computing entity configured and operable to perform any of the disclosed methods, processes, and operations.

### DETAILED DESCRIPTION OF SOME EXAMPLE EMBODIMENTS

Embodiments disclosed herein generally relate to the extraction of information from documents. More particularly, at least some embodiments relate to systems, hardware, software, computer-readable media, and methods for unsupervised multi-model optimization for resource-constrained document parsing at the edge.

In general, embodiments comprise methods that may resolve a double optimization problem that presents itself in some contexts, namely, optimizing both [1] a number of models to be used for extraction of information from one or more documents, and [2] a division of a document into various regions. An embodiment may use multi-objective genetic algorithm to optimize for the number of models and respective allocated region by using semantic matching as objective functions. There is a min-max relationship between having the smallest possible number of regions and, thus, the smallest number of models, while also ensuring that the regions of the document are semantically rich.

An example method according to one embodiment ay gather a representative dataset to train a multi-objective algorithm, where there are two main features to be optimized, that is, an embodiment may be considered as having multiple objectives. Such a method may comprise operations including, but not limited to: minimizing a number of regions in a 2D partition of a document, based on a maximum number of tokens that can be handled by a model class; maximizing a similarity among words in a common region; and, continuing to perform the minimizing and the maximizing until convergence to one or more acceptable solutions occurs.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a number of models needed for information extraction from a document may be minimized. An embodiment may maximize an identification of the similarity among words in a common region. In an embodiment, the aforementioned minimization and maximizing may be performed by a single method, possibly simultaneously. Various other advantages of one or more embodiments will be apparent from this disclosure.

### A. Context for One or More Embodiments

The following is a discussion of aspects of a context for various embodiments. This discussion is not intended to limit the scope of the claims or this disclosure, or the applicability of the embodiments, in any way.

### A.1 Specialized Information Extractor

The multimodal LLMs (large language model) OCR-free Document Understanding Transformer (DONUT) is specifically designed to extract document content without relying on traditional OCR. DONUT is trained to predict the next word by conditioning both the image and the preceding text, enabling it to “read” document components. A textual decoder then maps the extracted features into a sequence of sub-word tokens to construct structured outputs, such as JSON (JavaScript Object Notation). Each component of the model is transformer-based, with the available implementation encoder utilizing a Swin Transformer.

Like standard vision transformers, the Swin Transformer divides the input image into non-overlapping patches and applies a shifted window-based multi-head self-attention mechanism along with a two-layer MLP (multi-layer perceptron) to these patches. However, the Swin Transformer stands out with its hierarchical structure, which mimics convolutional neural networks (CNNs) by progressively splitting the image into different-sized patches. In the DONUT implementation, BART (Bidirectional and Auto-Regressive Transformer) language model is used for decoding, mapping the extracted features into a sequence of sub-word tokens to generate the output.

The model first learns to read document images, akin to an OCR (optical character recognition) task, by minimizing cross-entropy loss, which conditions next-token prediction on both image and text context. This training is performed on document images, much like any vision-language model. After learning to “read,” the model is fine-tuned to understand document images. During fine-tuning, the decoder generates a token sequence that is converted into a structured format, such as JSON, which is ideal for representing the desired output information. While generative models like DONUT excel at content extraction, they are computationally intensive, making them less suitable for deployment and use at edge devices.

### A.2 Genetic Algorithms

Genetic Algorithms (GAs) are a class of optimization algorithms inspired by the process of natural selection. GAs simulates the process of natural evolution by employing techniques such as selection, crossover (recombination), and mutation to evolve individuals (or solutions to problems). The main parameters of a GA are the population size (define the number of individuals in a population), the crossover rate (probability of combining two individuals forming a new solution to the problem), mutation rate (probability of randomly changing parts of a given solution), and the selection method (how individuals are chosen for reproduction).

The process starts from an initial population of solutions, then we evaluate each individual using a fitness function (a function that evaluates the quality of the solution), apply genetic operators (selection, crossover, and mutation) to generate the next population. The cycle continues until a termination condition is met, such as a maximum number of generations is achieved or until a solution with sufficient quality is found.

### B. Overview of Aspects of One or More Embodiments

As noted above, a significant problem in information extraction from documents is that having many information extraction models, such as LLMs, for many smaller regions, of a document, does not necessarily mean that the models can be, or are, smaller. In fact, models require a minimum size to be effective. Thus, an embodiment employs a trade-off between having more models to improve results, while keeping region allocation as semantically cohesive as possible and computation cost at a minimum. Thus, a double optimization problem is presented that may be effectively solved by an embodiment, where the parameters of the double optimization problem are, in brief: the best possible number of, or fewest, models; and, division of a document into regions. A related challenge is that of the expense of data annotation for a model and, thus, an embodiment may comprise an optimization method that is unsupervised.

In more detail, an embodiment comprises an approach for resolving the two-fold challenge above. To this end, an embodiment comprises and employs multi-objective genetic algorithm to optimize for the number of models and respective allocated region by using semantic matching as objective functions. There is a min-max relationship between having the smallest possible number of regions (and thus of models) and still have those regions semantically rich. More concretely, an embodiment may gather a representative dataset to train a multi-objective algorithm, where there are two main features to be optimized by the algorithm, namely, (i) minimizing a number of regions in the 2D (two dimensional) partition of a document from which content is to be extracted, thus minimizing the number of models needed to perform the extraction—note that this is subject to the maximum number of tokens a model class can handle, and (ii) maximizing a semantic similarity among words in the same region of a document. The semantic relationship between tokens may be considered by their embeddings through various techniques and metrics, for instance, cosine similarity or other clustering techniques. The embeddings could be performed by language models such as BERT, for instance.

The concept, in an embodiment, is to explore the trade-offs between conflicting objectives and generate a set of solutions known as the Pareto front, where no solution can be improved in one aspect without degrading another of the solutions in some way. This front represents a range of optimal solutions that may conflict with each other. In an embodiment, this process may continue recursively until convergence to a satisfactory set of solutions.

Thus, an embodiment comprises an adaptable and optimized infrastructure solution for document information extraction. To this end, an embodiment may utilize a combination of LLMs, semantic analysis of tokens, and optimization algorithms. By way of contrast with one or more embodiments, conventional approaches do not deal with limited compute at the edge, and so are unable to split a document to be parsed by multiple models in an optimal sense, where both semantics and computation are taken into account.

Embodiments may be employed in a variety of applications which involve or require the extraction of information from a set of documents, in which the documents of the set follow similar templates. Some example documents include: bill of lading (BoL) documents, which include logistics details about products handled between transport companies and clients; and, purchase orders (POs), which contain details of products a company is ordering.

These documents typically come in many different formats and templates. Yet, accurate information extraction is important, as fields like names, quantities, addresses, and values must match exactly to automate downstream processes that use the information extracted from such documents. Accordingly, one or more embodiments determine how to split these documents into smaller, more manageable sub-documents before feeding them into LLMs or other models, which significantly reduces errors. Specially, a method according to one embodiment helps the model avoid mixing information, or assigning information to the wrong field. For example, an embodiment prevents the model from confusing sender and recipient addresses or mixing up product names and their quantities, which could lead to issues later on.

### C. Detailed Discussion of Aspects of One or More Embodiments

### C.1 Context and Definitions

### C.1.1 Documents and Layout Elements

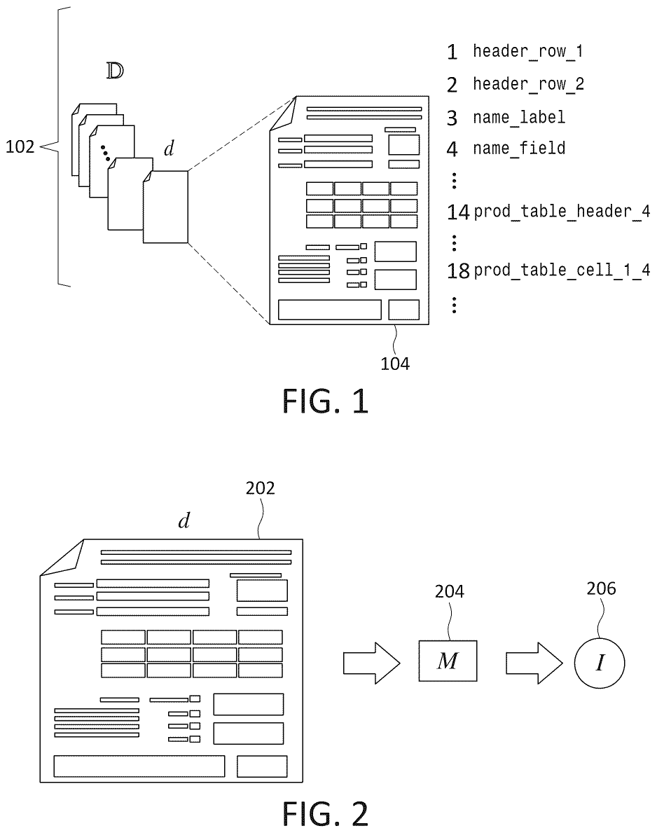

An embodiment may consider a set of documents [symbol] such that all documents d∈ [symbol] follow, or conform to, a template. As an example of this scenario, reference is made to a research project conducted by the inventors that dealt with information extraction from a set of Bill of Lading documents (BoLs) matching a common template. The scenario is represented in FIG. 1.

Particularly, FIG. 1 discloses a set of documents [symbol] 102. The documents in this set all conform to a common template 104 such that the documents all include, for example, two header rows, a name label, a name field, a product table header, and a product table cell.

The template 104 is defined by the elements, which occupy respective positions in the document layout. In the illustrative example of FIG. 1, some example elements are identified by a sequential id and a name.

Of course, alternative nomenclatures and types of fields can be assumed depending on the domain or template. The following set of types of elements is provided as an example:
Labels: the, often fixed-value, printed word-elements in a document, such as the labels accompanying fields. Certain labels can vary—for example, the header_row_1 element in FIG. 1 may vary from one document instance to another in the same template.
Fields: the variable elements in the document, fillable with arbitrary content in each document.
Segments: larger portions of the document such as the entire header, footer, legal disclaimers—or layout elements such as a company logo—may be assigned a single element id.
Table elements: each cell in the table, optionally with variable identifiers for header-cells.
   Each element in the layout may be assigned an identifier. The example of FIG. 1 assumes integer identifiers 0, 1, . . . arbitrarily assigned to the elements sequentially.

It is noted that the template 104 defines the positions and the type of content expected for each element, but not the content itself, for a document instance. For example—the element name_field in FIG. 1 is known to be at a certain relative position, which indicates a physical location/position in the document, but the actual “name” value written on a certain document instance is not known. To accurately obtain that value is the task of information extraction for a known template.

### C.1.2 Baseline Approach of Unsupervised Information Extraction with Multimodal Models

As described earlier herein, the recent developments enable information extraction to be performed via a multimodal model. In its most general form, the model-based information extraction task seeks to obtain the respective content of one or more of the elements, and also to obtain the respective identifications of the elements. A baseline approach in which the entire document is provided to a model is depicted in FIG. 2 which discloses, in particular, an example baseline approach for multimodal information extraction. In the example of FIG. 2, the entire document 202 is provided to a pretrained model M 204—but not finetuned to the template—to obtain the extraction I 206.

In the non-limiting example of FIG. 1, the model M 204 is a multimodal model and I 206 is the structured data, such as a dictionary for example, relating the document 202 elements (by id) and their content (the extracted value). For the case of a fixed template, particular interest may be paid to variable elements—in this example, usually fields and table-elements whose content may vary from one document to another.

### C.1.3 Region-Based Information Extraction

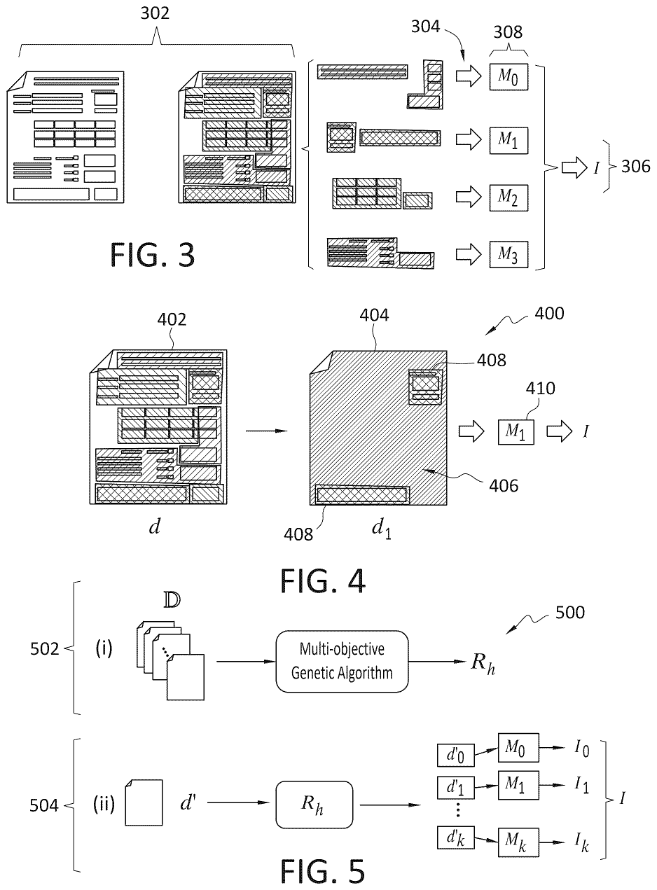

Given the issues with the baseline approach, discussed below, an embodiment implements an approach that comprises splitting of the template into discrete regions-such that each region treated separately by an instance of M yields enhanced results. This is depicted at a high level in FIG. 3 which discloses an example of a separation of a template 302 into various regions 304 (represented by shading) and the parallel information 306 extraction by models 308.

Here, the content of an instance of the document is then split into those regions, and each of those region contents are provided to an instance of model M 308 in parallel. The aggregate results of these parallel extractions I 306 is of enhanced quality when compared to the baseline approach discussed earlier herein. It is noted that an embodiment may assume certain properties of regions of a document, such as, but not limited to:
They are composed of the same elements as the document template-they are, effectively, each a valid ‘sub-document’ of a partial template.
As depicted in the example of FIGS. 1-3, these regions are not required to be contiguous.

To deal with these characteristics and enable the model M 204/308 to consider only the content of the region, an embodiment assume use of a masking procedure that can be applied to generate a copy of the document with everything outside of a specified region, or regions, erased or redacted. An example of this is disclosed in FIG. 4 which shows a masking procedure 400 used to generate, such as from a base document 402, a related ‘sub-document’ 404 that includes only a specified region, or regions. In an embodiment, the sub-document 404 is of same size as the original document 402 but has all content 406 outside the region(s) 408 obscured/erased.

In the example of FIG. 4, the ‘sub-document’ for the region 408 in the previous example. Thus, the model M₁ 410 does not have to be modified significantly, rather, it processes the sub-document d₁ 404 in the same way as it would process the original document d 402 but will find no relevant content outside of the region 408 delimited areas. Finally, an embodiment may assume that, and employ, a ‘self-similarity’ score for the content extracted from each region can be computed. This is discussed further below.

### C.1.4 Intuition of the Specific Problem and Solution

An embodiment may assume a restriction typical to the information extraction tasks—the task may be performed in unsupervised fashion, meaning that there are no ground truth examples of I for a relevant subset of [symbol] . Following are some concerns that arise in connection with the baseline approach introduced elsewhere herein:
Since no ground truth data is available, M cannot be easily finetuned for the template associated to [symbol] —as the supervised finetuning would require ground truth data.
The single pretrained model M may not be able to accurately extract the varied information in the entire document in a template that was not part of the training data for the model M.
The content of the document may not fit in the maximum input size (‘context’) of the model M.

One embodiment deals with these restrictions and aims at enhancing the quality of the information extraction. The region-based approach raises the problem of determining the optimal splitting of the template into regions.

Thus, an embodiment may operate to discover, from the unlabeled dataset [symbol] , the optimal splitting of the template into discrete regions—such that each region treated separately by an instance of M yields enhanced results. This is disclosed in FIG. 5 which discloses a schema 500 in which step (i) 502 takes place offline, such as outside or prior to a production scenario in which documents are being received and processed, while step (ii) 504 is performed online such as upon receipt of a new document d′.

In more detail, the example schema 500 of FIG. 5 comprises two phases:
(i) In offline fashion, an embodiment may perform an unsupervised optimization process to obtain a splitting strategy Rₕ suitable for [symbol] ; and
(ii) In online fashion, upon receiving a new document d′ of the same template as those in DD, an embodiment may apply Rₕ to obtain k regions. The sub-documents (see, e.g., FIG. 4) d₀′, d₁′, . . . , dₖ′ (each corresponding to a region) are processed in parallel by instances of M, and the resulting extractions are aggregated to compose the extracted information for the entire document d′.

An embodiment may employ a multi-objective genetic algorithm that considers a population of ‘document splitting’ strategies and outputs a (best) candidate Rₕ. An embodiment thus seeks, and implements, a strategy Rₕ that:
is efficient and fast for online application
   it must not include computationally expensive procedures for online application (see step (ii) 504 in the example of FIG. 5);
determines the appropriate number of regions;
   it must not require human input to determine the number of regions;
   it must not yield too few regions-which may make the information extraction unfeasible for a model instance M that has to deal with too much content;
   it must not yield too many regions-which would require too many model instances, and may split relevant contextual information that should be provided to the same model instance M; and
determines which elements are assigned to each region.
   To these ends, an embodiment comprises a fitness computation procedure that maximizes the self-similarity of the information Iⱼ extracted from the sub-documents dⱼ by M.

### C.2 Multi-Objective Genetic Algorithm

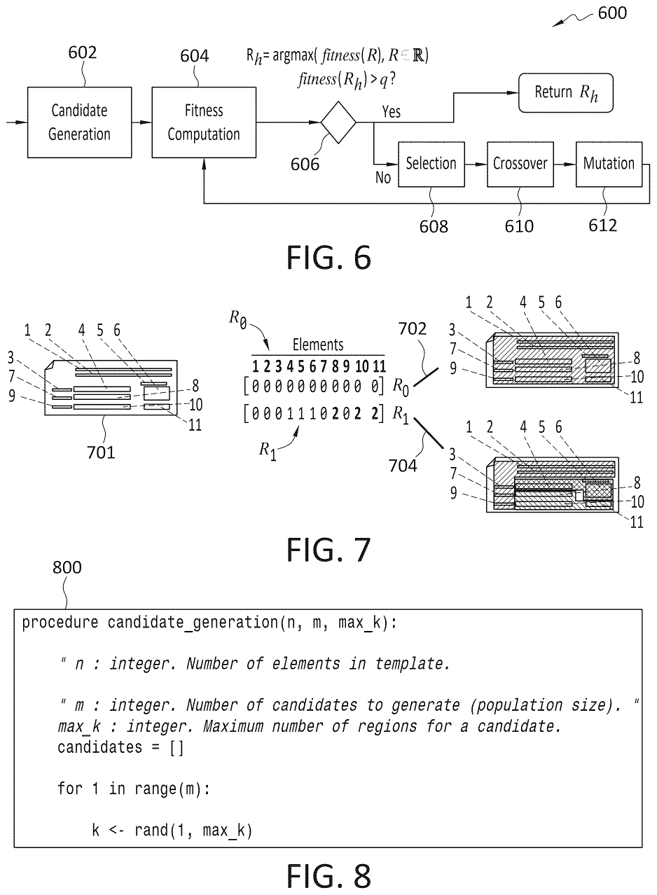

A multi-objective genetic algorithm method 600 according to one example embodiment is represented in FIG. 6 which discloses, more specifically, a multi-objective genetic algorithm approach to determine a substantially optimal document splitting strategy Rh.

As shown, an the method 600 may generate 602 an initial population [symbol] in the candidate generation step. Then, the method 600 may perform fitness computation 604 in a loop—in which each individual candidate strategy within the current population [symbol] is assigned 606 a fitness score-followed by the generation of a next population [symbol] in in three procedures, namely, selection 608, crossover 610, and mutation 612. The loop terminates upon finding that the best candidate Rₕ in the current population [symbol] has a fitness score above a termination threshold q, and then returning 614 the candidate document splitting strategy Rₕ.

With respect to one embodiment, it is noted that the candidate generation, crossover and mutation procedures are domain-dependent and may be customized in an embodiment. As well, the fitness computation performed in an embodiment is specific to the domain of information extraction, and implements a multi-objective selection, as discussed elsewhere herein.

### C.2.1 Candidate Generation

Recall from the definitions presented in ‘Documents and layout elements’ above that the template of the documents defines a set of n elements, each with a unique identifier. An embodiment may define a document splitting strategy R—one candidate in an embodiment of a genetic algorithm—as an array of n integers, each position determining the index of the ‘region’ for the corresponding element in that splitting strategy. A particular example, with a reduced document template, for ease of representation, is disclosed in FIG. 7.

More particularly, FIG. 7 discloses a schema 700 comprising two document splitting strategies—one R₀ 702 assigning all elements to the same region, and one R₁ 704 assigning elements to three distinct regions. One the left side of FIG. 7, there are shown the n=11 elements comprising a document template 701. The strategy R₀ 702 is defined assigning all elements to a same region (labeled 0). The strategy R₁ 704 assigns the elements to three regions (labeled 0, 1, 2).

Using this definition, an initial candidate generation procedure 800 may be defined, as shown in FIG. 8. When executed, the example procedure 800 generates m candidates, each comprising an array randomly assigning each element to one of k regions. The number of regions k is determined independently for each candidate.

### C.3 Fitness Computation

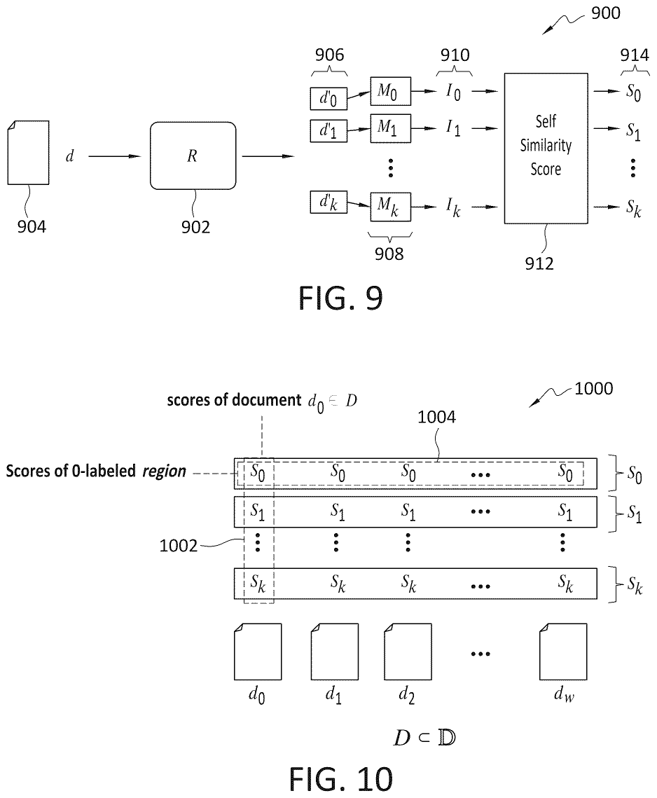

In an embodiment, the fitness computation computes, for an input candidate R, a score [0,1]. Since labels may not be available for the documents in [symbol] , a splitting strategy cannot be assessed based on the accuracy of the extraction obtained from the regions it determines. Thus, an embodiment may adopt the approach disclosed in FIG. 9 which comprises a method 900 of assessing a document splitting strategy R 902 for document d 904.

In more detail, and with continued reference to FIG. 9, the self-similarity scores s₀, s₁, . . . , sₖ are obtained by applying the splitting strategy, obtaining the sub-documents d′, d′, . . . d′, collectively denoted at 906, processing each individually, possibly in parallel, with respective instances of the model M, collectively denoted at 908. Each individual result, collectively shown at 910, of information extraction Iⱼ is separately input to the self-similarity score process 912, yielding a set 914 of corresponding scores sⱼ.

The self-similarity scoring 912 may vary, depending on the domain—mostly, on the output type of the information extraction models M 908. In the case of textual output, whether structured or unstructured, the average token perplexity of the extracted content, as computed by a sufficiently powerful generalist large language model, may be used to compose the similarity scores—with smaller perplexity values yielding larger scores s₀, s₁, . . . , meaning greater similarity.

Alternatively, the semantic relationship between tokens can be considered by their embeddings through various techniques and metrics, for instance, cosine similarity or other clustering techniques. The embeddings could be performed by language models such as BERT, for instance.

The method 900 of FIG. 9 is performed for multiple documents in [symbol] . This process is computationally expensive, although entirely offline and enabling the parallel application of the models over the sub-documents 906. To attenuate the impact of the computational costs, an embodiment may assume a document filtering process to select a set D⊂ [symbol] of representative documents only. The specific process may rely on external information, metadata clustering, or human feedback.

After applying the method 900 of FIG. 9 for all documents d E D, an embodiment may obtain a self-similarity score matrix 1000, as disclosed in FIG. 10. Particularly, FIG. 10 discloses self-similarity scores 1002 for documents D as obtained by the regions splitting strategy candidate R. The aggregate-by-region scores s₀, s₁, . . . , sₖ 1004 are the output for the strategy candidate R. With the aggregate-by-region scores s₀, s₁, . . . , sₖ 1004, an embodiment may compute the fitness of the strategy candidate R thus:

$$fitness ( R ) = α ( {max}_{k} - k ) + β \frac{( {\sum }_{i}^{k} {S}_{i} )}{k}$$

where:
R is the candidate, the document splitting strategy under consideration, represented by an array [a b . . . ] of k elements (see FIG. 7);
maxₖ is the maximum number of regions for each candidate, same as in the parametrization of the candidate generation procedure;
k is the number of regions determined by the candidate, i.e. the number of distinct values in R;
Sᵢ are the aggregate-by-region scores, as discussed above;
α is a factor that weighs having fewer regions; and
β is a factor that weighs having better average self-similarity in the regions.

In an embodiment, the parameters α and β are provided to balance the importance given to the competing criteria-smaller number of regions versus larger self-similarity. The fitness scores of the candidates are used for assessing whether a winning candidate is obtained or, otherwise, generating a next population of candidates.

### C.4 Winning Candidate Check

In an embodiment, this is a straightforward check-if the fitness of the best-scored candidate is above an acceptance threshold, the method may terminate and return that splitting strategy (candidate Rₕ). Alternatively, a set number of populations z may be generated and the best candidate in any of the populations [symbol] [symbol] may be returned instead. In an embodiment, this is a trivial modification for the termination check of the candidate fitness assessment loop and the implementation should be straightforward. Regardless of the termination check approach, the resulting candidate is a (near-)optimal region-splitting procedure for the documents following the template in [symbol] —which should include new documents, for online operation (see FIG. 5).

### C.5 New Population of Candidates

This process generates a new set of candidates [symbol] based on the candidates in the current population [symbol] . It uses the fitness of the candidates, as in genetic algorithm fashion.

### C.5.1 Selection

In an embodiment, a selection process is performed in genetic algorithm approaches. Thus, an embodiment may select the top-x % candidates ranked by fitness. From this, a small portion may be copied to the new population [symbol] directly. The others are considered for the crossover and mutation processes, discussed in the next sections. Optionally, as in general genetic algorithm approaches, a few non-top-x % candidates may be selected to account for larger variation in the populations. This is usually the case when local minima solutions may be too sub-optimal in comparison to the substantially optimal solutions.

### C.5.2 Crossover

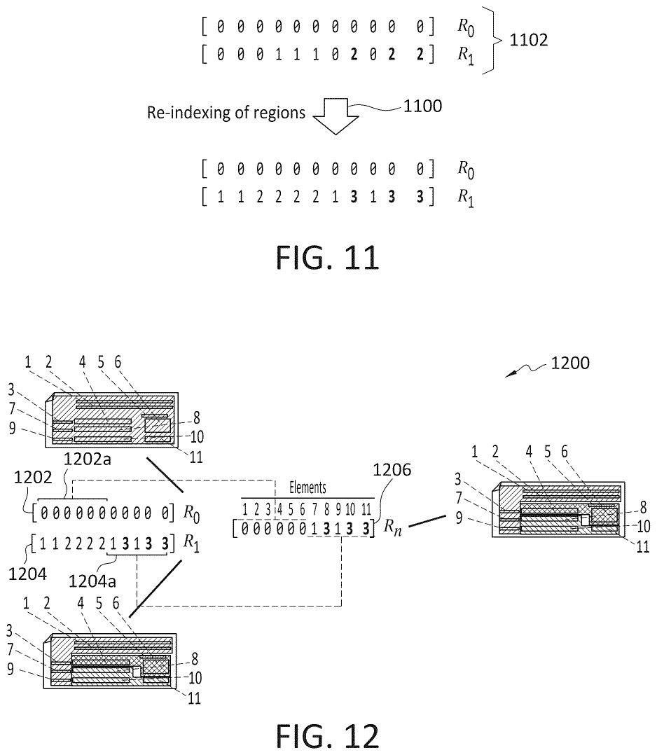

In one embodiment, the crossover process takes two random candidates Rₐ and R_{b} from the selected candidates, that is, from the selection process, and generates a new candidate for insertion in [symbol] . In more detail, this process may proceed as follows. An embodiment may start by re-indexing the regions in R_{b}, because the zero-index region in Rₐ is not the same as the zero-index region in R_{b}, and so forth. This is disclosed in FIG. 11, recapping the previous example from FIG. 7. In particular, FIG. 11 discloses the re-indexing 1100 of the regions 1102 in the second candidate (R₁, in the example). Formally, an embodiment may increment each element in R_{b} by the count of unique values in R₀. Then, an embodiment randomly take half of the region-indexes from Rₐ, and half from R_{b}. This is depicted in the example of FIG. 12 which discloses creation, by crossover of two candidates, a new candidate Rn.

In the example schema 1200 of FIG. 12, an embodiment may take the first half 1202a from the first candidate R₀ 1202 and the second half 1204a from the second candidate R₁ 1204 to create the new candidate Rn 1206. It is noted that this is a simple example provided for the purposes of illustration. In practice, a procedure of taking random positions from each candidate is possible, as are more complex approaches such as taking regions from a first candidate accounting for nearly half of the elements, then the remaining elements from the other.

It is noted that that the crossover method of the example schema 1200 may sometimes increase the number of regions of a document, that is, the new candidates generated may have more regions than either parent. Thus, a pruning filter of discarding candidates with more than maxk regions may be employed in some circumstances. An embodiment may also account for the reduction in number of regions in the mutation process.

The number of new candidates generated by a crossover process according to one embodiment may take into account the number of candidates added to the new population [symbol] in the selection process and the desired population size. The crossover may either fill the remaining spots in the next population entirely, or optionally leave a few spots for ‘forced’ mutation.

### C.5.3 Mutation

In an embodiment, the mutation process follows a crossover process (see, e.g., FIG. 6). If spots in the next population [symbol] have not been filled by the selection and crossover processes, an embodiment may generate those candidates by ‘forced mutation.’ This approach accounts for increased variability in the number and configuration of regions in the next population and is typically preferrable when multiple good solutions exist in the domain. In this case, an embodiment may apply the mutation mechanism, defined below, assigning a probability of

$$\frac{1}{k}$$

for each element. Regardless of such forced mutations or not, the mutation process may be applied randomly over candidates already included in the next generation.

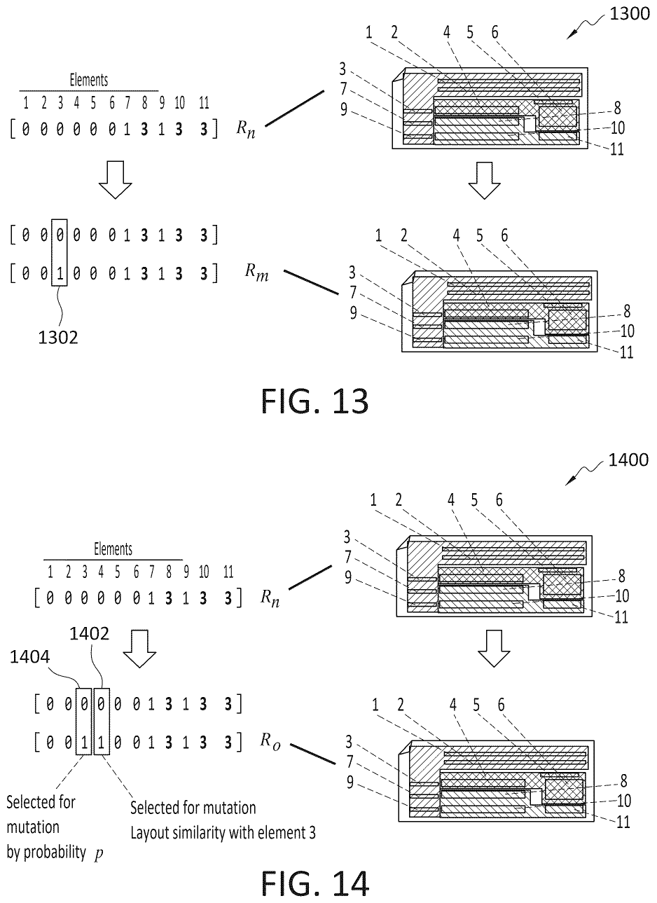

In an embodiment, a basic mutation mechanism may operate as follows. For each element in each candidate R in [symbol] consider a probability p of changing that element to another existing region, that is, to change the value of that element in R to another pre-existing unique value. An example of this approach is disclosed in FIG. 13.

Particularly, the schema 1300 of FIG. 13 discloses an example of a single-element mutation 1302 resulting from changing the region of the element with index 3, from region 0 to (pre-existing) region 1. This mechanism will necessarily keep the same number of regions, or decrement the total number of regions in the candidate, when selecting for mutation the single element of a region. This approach may thus act as a counterpart to the sporadically region-increasing effect of the crossover mechanism, discussed above.

Consider that changing the elements one by one may cause slow convergence towards candidates with fewer number of regions. In that case, an embodiment may alter the rate of mutation, that is, the probability p may be decreased, to account for more drastic mutations, such as changes of multiple elements at once. This is depicted in the example of FIG. 14.

Particularly, FIG. 14 discloses alternative multi-element mutation 1400 in a same scenario. The region of element 1402 with index 4 is changed to match the change in element 1404 with index 3, since they are related in the layout, that is, element 3 is a label associated to a field, element 4. This latter approach may be particularly valuable when ‘layout cues’ can be obtained-such as the proximity or visual similarity, possibly indicated by font size, and font type, for example, of elements, indicating that such elements should be considered as part of the same region. While the genetic algorithm could naturally account for that, such as by awarding greater fitness values for such candidates, the ‘guiding’ of the mutation process towards domain-dependent characteristics may greatly increase the convergence towards a feasible candidate.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments. These are presented only by way of example and are not intended to limit the scope of this disclosure or the claims in any way.

Embodiment 1. A method for extracting content from a document, comprising: receiving a new document that conforms to a template that is common to one or more documents in a set of documents; applying a splitting strategy to the new document that splits the new document into regions; defining a set of sub-documents, each of the sub-documents corresponding to one of the regions; using respective instances of an LLM (large language model), extracting respective content from each of the sub-documents; and aggregating the content of the sub-documents to define structured data relating elements of the template and their content to the new document.

Embodiment 2. The method as recited in any preceding embodiment, wherein the LLMs performing the extracting in parallel with each other.

Embodiment 3. The method as recited in any preceding embodiment, wherein the sub-documents are each smaller in size than the new document, and in each of the sub-documents, any content outside of the region to which that sub-document corresponds is not fed to the LLM for the extracting.

Embodiment 4. The method as recited in any preceding embodiment, wherein a number of the LLMs used for content extraction was optimized using a multi-objective genetic algorithm.

Embodiment 5. The method as recited in any preceding embodiment, wherein a number of the regions into which the new document was split was optimized using a multi-objective genetic algorithm.

Embodiment 6. The method as recited in any preceding embodiment, wherein a min-max approach was used to determine a smallest possible number of the regions while maximizing a self-similarity of the respective content extracted from each of the sub-documents.

Embodiment 7. The method as recited in any preceding embodiment, wherein the template defines positions and a type of content expected for each element of the template, but the template does not include any content itself.

Embodiment 8. The method as recited in any preceding embodiment, wherein the extracting of respective content is performed by the LLMs in an unsupervised manner.

Embodiment 9. The method as recited in any preceding embodiment, wherein each of the LLMs was pretrained, but not fine-tuned to the template.

Embodiment 10. The method as recited in any preceding embodiment, wherein the splitting strategy was obtained using an unsupervised optimization process.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

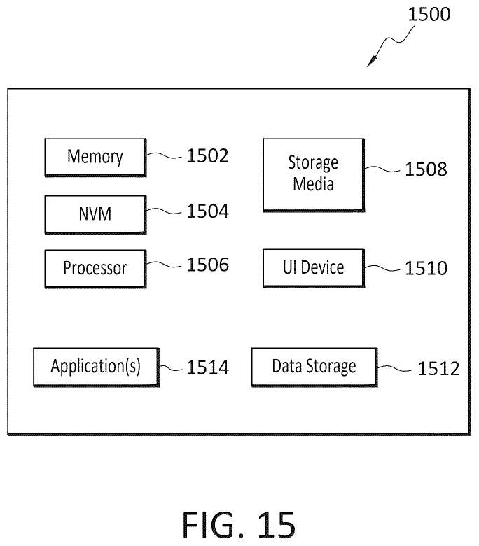

With reference briefly now to FIG. 15, any one or more of the entities disclosed, or implied, by FIGS. 1-14, and/or elsewhere herein, may take the form of, or include, or be implemented on, or hosted by, a physical computing device, one example of which is denoted at 1500. As well, where any of the aforementioned elements comprise or consist of a virtual machine (VM), that VM may constitute a virtualization of any combination of the physical components disclosed in FIG. 15.

In the example of FIG. 15, the physical computing device 1500 includes a memory 1502 which may include one, some, or all, of random access memory (RAM), non-volatile memory (NVM) 1504 such as NVRAM for example, read-only memory (ROM), and persistent memory, one or more hardware processors 1506, non-transitory storage media 1508, UI device 1510, and data storage 1512. One or more of the memory components 1502 of the physical computing device 1500 may take the form of solid state device (SSD) storage. As well, one or more applications 1514 may be provided that comprise instructions executable by one or more hardware processors 1506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for extracting content from a document, comprising:
receiving a new document that conforms to a template that is common to one or more documents in a set of documents;
applying a splitting strategy to the new document that splits the new document into regions;
defining a set of sub-documents, each of the sub-documents corresponding to one of the regions;
using respective instances of an LLM (large language model), extracting respective content from each of the sub-documents; and
aggregating the content of the sub-documents to relate, for the new document, the elements of the template to their respective content.

2. The method as recited in claim 1, wherein the LLMs perform the extracting in parallel with each other.

3. The method as recited in claim 1, wherein the sub-documents are each smaller in size than the new document, and in each of the sub-documents, any content outside of the region to which that sub-document corresponds is not fed to the LLM for the extracting.

4. The method as recited in claim 1, wherein a number of the LLMs used for content extraction was optimized using a multi-objective genetic algorithm.

5. The method as recited in claim 1, wherein a number of the regions into which the new document was split was optimized using a multi-objective genetic algorithm.

6. The method as recited in claim 1, wherein a min-max approach was used to determine a smallest possible number of the regions while maximizing a self-similarity of the respective content extracted from each of the sub-documents.

7. The method as recited in claim 1, wherein the template defines positions and a type of content expected for each element of the template, but the template does not include any content itself.

8. The method as recited in claim 1, wherein the extracting of respective content is performed by the LLMs in an unsupervised manner.

9. The method as recited in claim 1, wherein each of the LLMs was pretrained, but not fine-tuned to the template.

10. The method as recited in claim 1, wherein the splitting strategy was obtained using an unsupervised optimization process.

11. A non-transitory storage medium having stored therein instructions that are executable by one or more hardware processors to perform a method for extracting content from a document, the method including operations comprising:
receiving a new document that conforms to a template that is common to one or more documents in a set of documents;
applying a splitting strategy to the new document that splits the new document into regions;
defining a set of sub-documents, each of the sub-documents corresponding to one of the regions;
using respective instances of an LLM (large language model), extracting respective content from each of the sub-documents; and
aggregating the content of the sub-documents to define structured data relating elements of the template and their content to the new document.

12. The non-transitory storage medium as recited in claim 11, wherein the LLMs performing the extracting in parallel with each other.

13. The non-transitory storage medium as recited in claim 11, wherein the sub-documents are each smaller in size than the new document, and in each of the sub-documents, any content outside of the region to which that sub-document corresponds is not fed to the LLM for the extracting.

14. The non-transitory storage medium as recited in claim 11, wherein a number of the LLMs used for content extraction was optimized using a multi-objective genetic algorithm.

15. The non-transitory storage medium as recited in claim 11, wherein a number of the regions into which the new document was split was optimized using a multi-objective genetic algorithm.

16. The non-transitory storage medium as recited in claim 11, wherein a min-max approach was used to determine a smallest possible number of the regions while maximizing a self-similarity of the respective content extracted from each of the sub-documents.

17. The non-transitory storage medium as recited in claim 11, wherein the template defines positions and a type of content expected for each element of the template, but the template does not include any content itself.

18. The non-transitory storage medium as recited in claim 11, wherein the extracting of respective content is performed by the LLMs in an unsupervised manner.

19. The non-transitory storage medium as recited in claim 11, wherein each of the LLMs was pretrained, but not fine-tuned to the template.

20. The non-transitory storage medium as recited in claim 11, wherein the splitting strategy was obtained using an unsupervised optimization process.
